(19) United States
(12) Patent Application Publication
(10) Pub. No.: US 2012/0064382 A1
(43) Pub. Date: Mar. 15, 2012

(54) ELECTRODE ASSEMBLY AND SECONDARY BATTERY USING THE SAME

(76) Inventor: Chang-Bum Ahn, Yongin-si (KR)

(21) Appl. No.: 13/109,939

(22) Filed: May 17, 2011

(30) Foreign Application Priority Data
Sep. 9, 2010 (KR) 10-2010-0088393

(51) Int. Cl. H01M 4/02; H01M 2/02; H01M 2/26; H01M 2/18; H01M 10/36

(52) U.S. Cl. 429/94; 429/209; 429/136; 429/160; 429/163

(57) ABSTRACT

An electrode assembly includes a first electrode member; a second electrode member; a plurality of first guide portions, wherein at least one of the first guide portions is on the first electrode member; a plurality of second guide portions, wherein at least one of the second guide portions is on the second electrode member; and a separator located between the first electrode member and the second electrode member, wherein the electrode assembly has a first region at which the first guide portions are coupled together and a second region at which the second guide portions are coupled together.

### CROSS-REFERENCE TO RELATED APPLICATION

This application claims priority to and the benefit of Korean Patent Application No. 10-2010-0088393, filed on Sep. 9, 2010, in the Korean Intellectual Property Office, the entire content of which is incorporated herein by reference.

### BACKGROUND

1. Field of the Invention

An aspect of the present invention relates to an electrode assembly and a secondary battery using the same.

2. Description of the Related Art

In general, an electrode assembly includes a positive electrode plate, a negative electrode plate and a separator located therebetween. A secondary battery is manufactured by accommodating the electrode assembly and an electrolyte in a battery case.

An electrode assembly including a plurality of positive electrode plates, a plurality of negative electrode plates and a separator may be used in a high-capacity secondary battery. In the electrode assembly having such a configuration, it is difficult to precisely align the electrode plates as the number of the electrode plates is increased.

### SUMMARY

Embodiments provide an electrode assembly and a secondary battery using the same capable of easily aligning positive and negative electrode plates.

According to an aspect of the present invention, there is provided an electrode assembly including a first electrode member; a second electrode member; a plurality of first guide portions, wherein at least one of the first guide portions is on the first electrode member; a plurality of second guide portions, wherein at least one of the second guide portions is on the second electrode member; and a separator located between the first electrode member and the second electrode member, wherein the electrode assembly has a first region at which the first guide portions are coupled together and a second region at which the second guide portions are coupled together.

In one embodiment, the first electrode member and the second electrode member each include an active material layer coated with an active material and a non-coating portion at which the active material is not coated, and wherein the first guide portions and the second guide portions are located in the non-coating portion of the first electrode member and the second electrode member, respectively. Additionally, the first electrode member and the second electrode member may be alternately stacked so that the first guide portions and the second guide portions are at opposite sides of the electrode assembly from each other.

In one embodiment, the separator is a sheet that is folded onto itself a plurality of times so that a first surface of the separator faces itself. Further, in one embodiment, the first guide portions are coupled together by first fixing portions and the second guide portions are coupled together by second fixing portions. The first fixing portions and the second fixing portions may be rivets that pass through the guide portions. Additionally, welding portions may be further formed generally adjacent to each of the rivets.

In another embodiment, a secondary battery is provided including an electrode assembly having a first electrode member; a second electrode member; a plurality of first guide portions, wherein at least one of the first guide portions is on the first electrode member; a plurality of second guide portions, wherein at least one of the second guide portions is on the second electrode member; and a separator located between the first electrode member and the second electrode member, wherein the electrode assembly has a first region at which the first guide portions are aligned together and a second region at which the second guide portions are aligned together; and a case accommodating the electrode assembly. The case may be a pouch-type case.

As described above, in the electrode assembly according to the embodiments of the present invention, one or more guide portions are formed in the non-coating portion of each of the positive and negative electrode plates to form a passage, so that the positive and negative electrode plates can be easily aligned regardless of the stacking or winding number of the electrode plates.

Also, the electrode members can be more firmly fastened using fixing portions that pass through the guide portions.

Also, in the secondary battery using the electrode assembly according to the embodiments, the safety and reliability of the secondary battery can be enhanced, and failure that may occur in a manufacturing process can be reduced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a secondary battery having an electrode assembly according to an embodiment of the present invention.

FIG. 2 is an exploded perspective view of the electrode assembly shown in FIG. 1.

FIG. 3 is a sectional view taken along line A-A′ of FIG. 1.

FIG. 4 is a perspective view of the electrode assembly shown in FIG. 1.

FIG. 5 is an exploded perspective view of an electrode assembly according to another embodiment of the present invention.

FIG. 6A is a plan view showing an upper surface of the electrode assembly according to the embodiment of the present invention.

FIG. 6B is a sectional view taken along line B-B′ of FIG. 6A.

FIG. 7 is an exploded perspective view of an electrode assembly according to still another embodiment of the present invention.

FIG. 8A is a plan view showing an upper surface of the electrode assembly shown in FIG. 7.

FIG. 8B is a sectional view taken along line C-C′ of FIG. 8A.

FIG. 9 is a perspective view of a secondary battery using the electrode assembly according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

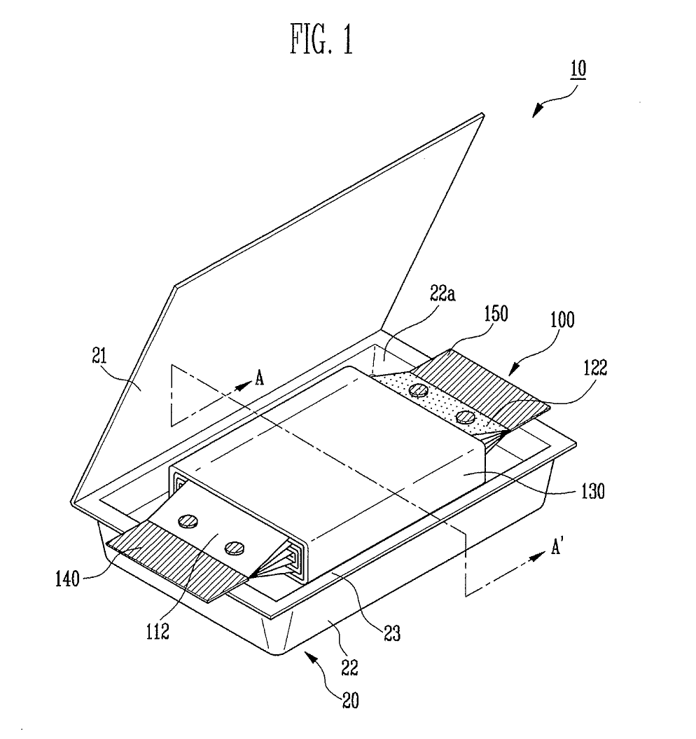

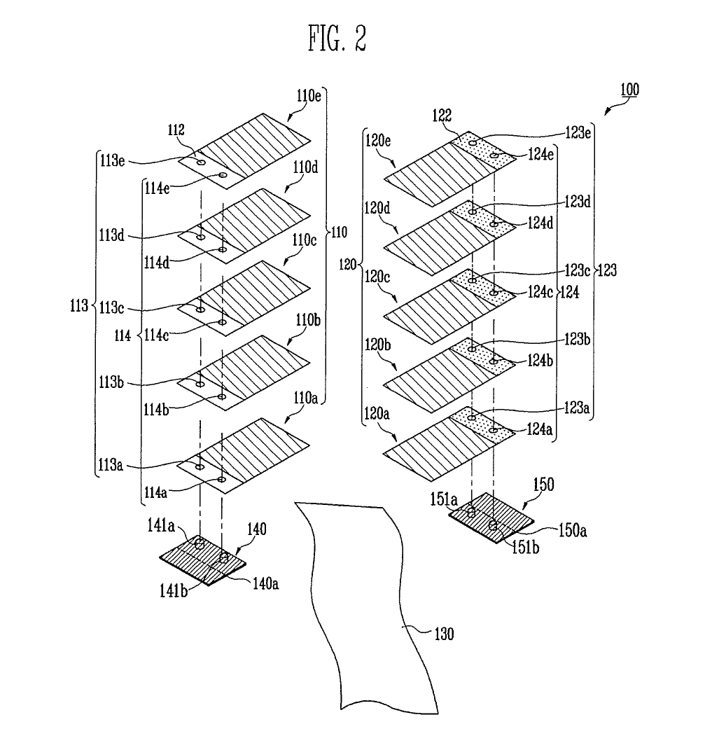

FIG. 1 is a perspective view of a secondary battery having an electrode assembly according to an embodiment of the present invention. FIG. 2 is an exploded perspective view of the electrode assembly shown in FIG. 1.

As shown in FIG. 1, the secondary battery 10 according to this embodiment is a pouch-type secondary battery, and includes a battery case 20 and an electrode assembly 100 accommodated in the battery case 20.

The battery case 20 may include a cover 21 and a body 22. The body 22 is provided with an accommodating portion 22a that is a space for accommodating the electrode assembly 100, and a flange-shaped sealing portion 23 formed to be extended to the outside from the side of an entry of the accommodating portion 22a. The cover 21 is integrally connected with one side of the sealing portion 23. The electrode assembly 100 is accommodated in the accommodating portion 22a of the body 22, and the sealing portion 23 is then thermally fused such that the body 22 and the cover 21 are adhered closely to each other.

The electrode assembly 100 according to this embodiment includes a first electrode member 110 having at least one first guide portion, a second electrode member 120 having at least one second guide portion, and a separator 130 located between the first and second electrode members 110 and 120. The electrode assembly 100 has a region combined by one or more of the first and second guide portions. The first and second guide portions may be an opening.

The first electrode member 110 includes a first active material layer formed by coating a first active material on a portion of a collector, and a first non-coating portion 112 at which the first active material is not coated on the collector. Hereinafter, the first electrode member 110 is referred to as a positive electrode plate for convenience of illustration. Generally, the positive electrode collector is made of a material having high conductivity, and the material is not particularly limited as long as it does not induce a chemical change. The positive electrode active material layer includes a positive electrode active material that is a layered compound containing lithium, a conductive material for improving conductivity, and a binder for improving the cohesion between the layered compound and the conductive material.

The first non-coating portion 112 may include one or more first guide portions. Although it has been illustrated in FIG. 2 that the first guide portions are provided with first openings 113a, 113b, 113c, 113d and 113e and second openings 114a, 114b, 114c, 114d and 114e, the location and number of holes are not limited thereto. Hereinafter, for convenience of illustration, the first and second holes will be designated by reference numerals 113 and 114, respectively. In the non-coating portion 112, the first and second holes 113 and 114 may be formed at the positive electrode collector using a general operation of forming holes, such as a drilling or punching operation. In this instance, the first and second holes 113 and 114 may be formed in a circular shape.

Since it is sufficient that each of the first holes 113 and the second holes 114 are formed at the same position in positive electrode plates 110a, 110b, 110c, 110d and 110e, they are not limited to the position. In a case where the positive electrode plates 110a, 110b, 110c, 110d and 110e are stacked so that the first non-coating portions 112 face the same direction, each of the first holes 113 and the second holes 114 are located at generally the same position in the first non-coating portions 112. Thus, the first holes 113 are aligned with one another to form a passage, and the second holes 114 are aligned with one another to form a passage.

The second electrode member 120 includes a second active material layer formed by coating a second active material on a collector, and a second non-coating portion 122 at which the second active material is not coated on the collector. Hereinafter, the second electrode member 120 is referred to as a negative electrode plate for convenience of illustration. Generally, the negative electrode collector may be formed of a conductive metal. The negative electrode active material layer is formed by mixing a negative electrode active material and a binder for improving the cohesion of the negative electrode active material with a solvent to form a slurry and then coating the slurry on the negative electrode collector.

The second non-coating portion 122 may include one or more second guide portions. Although it has been illustrated in FIG. 2 that the first guide portions are provided with third holes 123a, 123b, 123c, 123d and 123e and fourth holes 124a, 124b, 124c, 124d and 124e, the location and number of holes are not limited thereto. Hereinafter, for convenience of illustration, the third and fourth holes will be designated by reference numerals 123 and 124, respectively. In the non-coating portion 122, the third and fourth holes 123 and 124 may be formed at the positive electrode collector using a general operation of forming holes, such as a drilling or punching operation.

It is sufficient that each of the third holes 123 and the fourth holes 124 are formed at generally the same position in negative electrode plates 120a, 120b, 120c, 120d and 120e. Thus, when the negative electrode plates 120a, 120b, 120c, 120d and 120e are stacked so that the second non-coating portions 122 face the same direction, the third holes 123 are aligned with one another to form a passage, and the fourth holes 124 are aligned with one another to form a passage.

The separator 130 may formed to be extended in a sheet shape. The separator 130 allows a passage of ions and prevents the first and second electrode members 110 and 120 from coming in direct contact with each other, and thereby becoming electrically connected.

The electrode assembly 100 according to this embodiment is provided with the passages through which the first and second guide portions formed on the first and second non-coating portions 112 and 122 of the first and second electrode members 110 and 120 are connected to one another, respectively. The first and second guide portions are combined together so that the plurality of first and second electrode members 110 and 120 can be fastened and fixed, respectively. In this instance, the first and second guide portions may be fastened by passing separate fixing portions through the passages, respectively.

The fixing portions may include rivets. In this instance, the rivets pass through the passages of the first and second guide portions, so that the first and second guide portions can be fastened together, respectively. After a riveting operation is performed, a separate welding operation may be performed with respect to surrounding portions of the rivets so that the first and second portions can be more firmly fastened.

In order to describe in detail the riveting operation for the fastening of the first and second portions, a case where an electrode lead that is a portion for electrically connecting the electrode assembly to the outside of secondary battery will be described in a more detailed manner.

The electrode assembly 100 according to this embodiment may further include first and second electrode leads 140 and 150.

The first and second electrode leads 140 and 150 are attached to the first and second non-coating portions 112 and 122 of the first and second electrode members 110 and 120, respectively, so that the electrode assembly 100 is electrically connected to the exterior of the secondary battery.

The first and second electrode leads 140 and 150 may be provided with fixing portions, respectively. The fixing portions may be projections or rivets. In this embodiment, projections are used as the fixing portions.

That is, the first and second electrode leads 140 and 150 may be further provided with first projections 141a and 141b that pass through the first guide portions and second projections 151a and 151b that pass through the second guide portions, respectively. The first and second projections 141a, 141b, 151a and 151b may be formed to be spaced apart at a constant interval. In this instance, the size and height of the projections may be formed to be identical. The first and second projections pass through the passages formed by the holes provided to the electrode plates, so that the electrode leads 140 and 150 are fastened to the first and second electrode members 110 and 120, respectively. Through the holes and projections, the first and second electrode leads 140 and 150 can be firmly fastened to the first and second electrode members 110 and 120, respectively. That is, in this embodiment, the first and second projections 141a, 141b, 151a and 151b formed on the first and second electrode leads 140 and 150 are fixing portions, and perform substantially the same function as the rivets.

Welding portions may be further formed at surroundings of the first and second projections 141a, 141b, 151a and 151b that pass through the first and second guide portions. The welding portions may be formed using a resistance welding, laser welding or the like. Through the welding portions, the first and second electrode leads 140 and 150 are more firmly fastened to the first and second electrode members 110 and 120, respectively.

In the first and second leads 110 and 120, the position and number of the first and second projections 141a, 141b, 151a and 151b are not particularly limited. On the other hand, when considering process efficiency and the like, the first and second projections 141a, 141b, 151a and 151b may be spaced from the center portions 140a and 150a of the first and second electrode leads 110, 120, respectively. The first and second electrode leads 140 and 150 may be formed of the same material in the same shape.

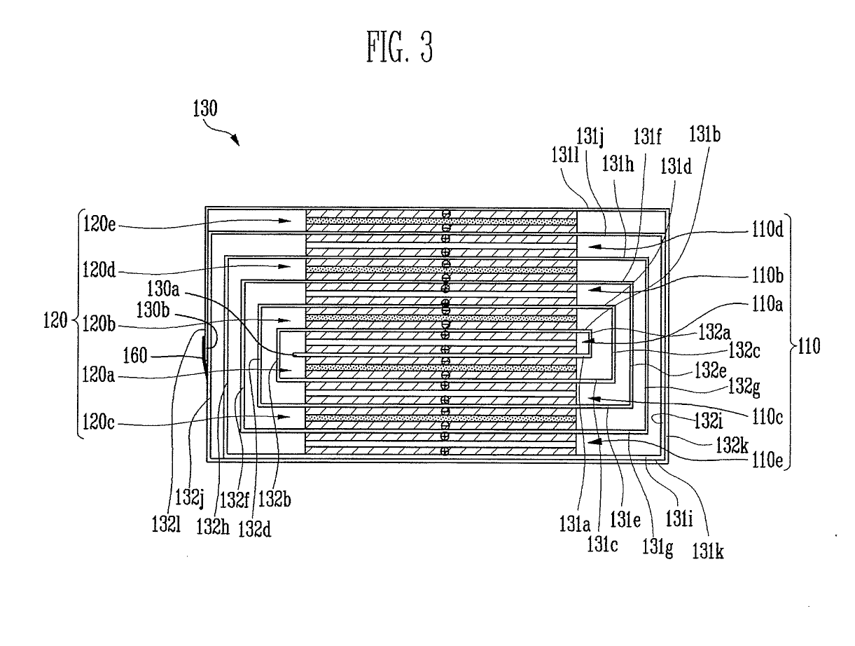

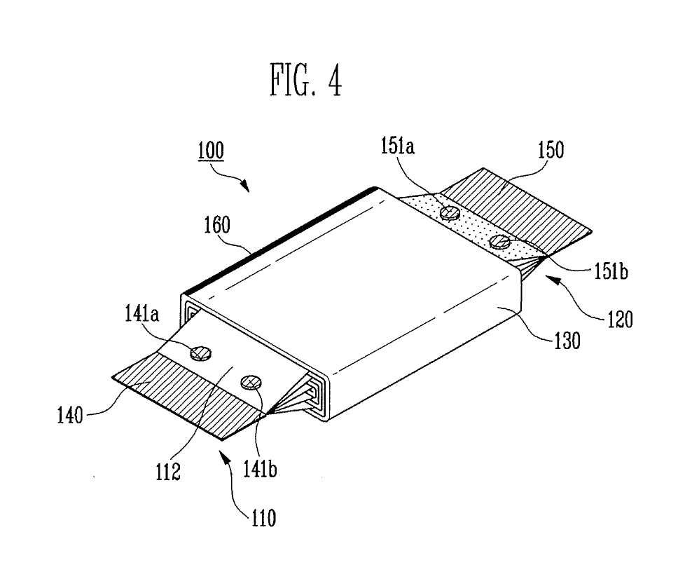

FIG. 3 is a sectional view taken along line A-A′ of FIG. 1. FIG. 4 is a perspective view of the electrode assembly shown in FIG. 1.

Referring to FIG. 3, the separator 130 is wound counterclockwise from a center portion 130a thereof. The separator 130 wound as described above includes one or more facing portions 131a, 131b, 131c, 131d, 131e, 131f, 131g, 131h, 131i, 131j, 131k and 131l, and one or more connecting portions 132a, 132b, 132c, 132d, 132e, 132f, 132g, 132h, 132i, 132j, 132k and 1321 that connect the facing portions 131a, 131b, 131c, 131d, 131e, 131f, 131g, 131h, 131i, 131j, 131k and 131l. The one or more facing portions 131a, 131b, 131c, 131d, 131e, 131f, 131g, 131h, 131i, 131j, 131k and 131l are positioned between the positive electrode plates 110a, 110b, 110c, 110d and 110e and the negative electrode plates 120a, 120b, 120c, 120d and 120e so as to prevent the positive electrode plates 110a, 110b, 110c, 110d and 110e from coming in direct contact with the negative electrode plates 120a, 120b, 120c, 120d and 120e. An outer end 130b of the separator 130 is attached to an outermost side of the separator 130 by an adhesive tape 160.

The positive electrode plate 110a, 110b, 110c, 110d and 110e and the negative electrode plate 120a, 120b, 120c, 120d and 120e are alternately stacked between the respective facing portions 131a, 131b, 131c, 131d, 131e, 131f, 131g, 131h, 131i, 131j, 131k and 131l of the separator 130. Referring to FIG. 3, the positive electrode plate 110a is positioned between the facing portions 131a and 131b of the separator 130, and the separator 130 is wound while surrounding upper and lower surfaces of the positive electrode plate 110a. The negative electrode plate 120a is stacked at a lower side of the positive electrode plate 110a with the separator 130 located therebetween, and is between the other facing portions 131a and 131c of the separator 130. As described above, the positive electrode plates 110a, 110b, 110c, 110d and 110e and the negative electrode plates 120a, 120b, 120c, 120d and 120e are stacked with the separator 130 located therebetween, thereby forming the electrode assembly 100 according to this embodiment.

In the electrode assembly 100, the first electrode member 110 that is a positive electrode plate and the second electrode member 120 that is a negative electrode may be stacked so that the first and second non-coating portions 112 and 122 face opposite directions to each other (see FIG. 1). Adjacent electrode plates are aligned so that their center portions are aligned with each other with the separator 130 located therebetween. Thus, in the first non-coating portions 112 of the first electrode members 110, the first holes 113 are aligned with one another to form a passage, and the second holes 114 are aligned with one another to form a passage. As described above, in the second non-coating portions 122 of the second electrode members 120, the third holes 123 are aligned with one another to form a passage, and the fourth holes 124 are aligned with one another to form a passage (see FIG. 2).

Referring to FIG. 4, the first electrode member 110 that is a positive electrode plate and the second electrode member 110 that is a negative electrode plate are alternately stacked, and the separator 130 is located between the first and second electrode members 110 and 120. In this instance, the first and second non-coating portions 112 and 122 are exposed in the opposite directions to each other through the separator 130. The outer end of the separator 130 is fixed using the adhesive tape 160.

Thus, in the electrode assembly 100 according to this embodiment, the adjacent first and second electrode members 110 and 120 are stacked with the facing portions 131a, 131b, 131c, 131d, 131e, 131f, 131g, 131h, 131i, 131j, 131k and 131l of the separator 130 located therebetween so that their center portions are aligned with each other. In this instance, the first and second non-coating portions 112 and 122 of the first and second electrode members 110 and 120 are exposed to face opposite directions to each other with the separator 130 located therebetween, so that first non-coating portions are aligned and the second non-coating portions are aligned. Thus, in the holes in the first and second non-coating portions 112 and 122, the holes that are aligned form a passage.

In this embodiment, the holes that exist in the first and second non-coating portions 112 and 122 serve as guides when the first and second electrode members 110 and 120 are stacked. Thus, the center portions of the electrode plates can be more easily aligned. The positive electrode active material layer of the first electrode member 110 faces the negative electrode active material layer of the second electrode member 120 at generating the same position with the separator 130 located therebetween, and such stacking is repeated, thereby forming the electrode assembly 100 according to this embodiment.

The secondary battery using the electrode assembly 100 manufactured as described above has enhanced performance such as life span and charge/discharge efficiency.

In FIG. 4, the first and second non-coating portions 112 and 122 of the first and second electrode members 110 and 120 are integrally fastened using a method such as welding to form welding portions, respectively. The welding portions are connected to the first and second electrode leads 140 and 150, respectively. In this instance, each of the first and second projections 141a, 141b, 151a and 151b of the first and second electrode leads 140 and 150 passes through the passage formed by the plurality of holes on the first and second non-coating portions 112 and 122. Thus, the electrode leads and the electrode assembly are stably fastened by the projections.

In FIG. 4, the non-coating portions are formed as welding portions, and the welding portions and the electrode lead are then connected to the electrode assembly. However, the electrode lead may be connected to the electrode assembly not by forming a welding portion, but rather by directly passing the projections of the electrode lead through the holes of the non-coating portions. The interval between the first and second projections 141a, 141b, 151a and 151b is determined by the interval between the holes provided to the first and second non-coating portions 112 and 122 of the electrode assembly 100. The height of the first and second projections 141a, 141b, 151a and 151b may also be properly modified according to the thickness of the electrode assembly 100.

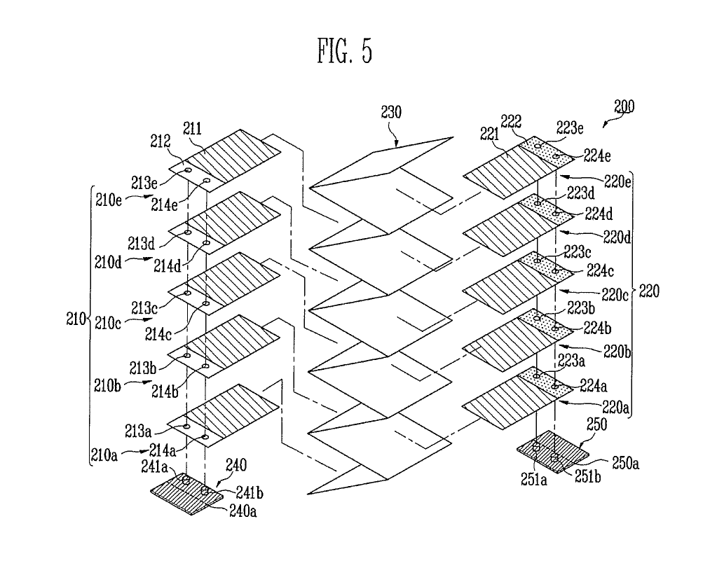

FIG. 5 is an exploded perspective view of an electrode assembly according to another embodiment of the present invention.

Referring to FIG. 5, the electrode assembly 200 includes a first electrode member 210, a second electrode member 220, a separator 230, a first electrode lead 240 and a second electrode lead 250.

Since the configuration and operation of the first and second electrode members 210 and 220 and the first and second electrode leads 240 and 250 are substantially similar to those described in the embodiment of FIG. 2, their detailed descriptions will be omitted.

As shown in FIG. 5, the electrode assembly 200 according to this embodiment includes positive electrode plates 210a, 210b, 210c, 210d and 210e, negative electrode plates 220a, 220b, 220c, 220d and 220e alternately stacked with the positive electrode plates 210a, 210b, 210c, 210d and 210e, and a separator 230. The separator 230 is located between the positive electrode plates 210a, 210b, 210c, 210d and 210e and the negative electrode plates 220a, 220b, 220c, 220d and 220e while being folded a plurality of times so that the same surfaces of the separator 230 face each other. The separator 230 may be extended in a sheet shape. The separator 230 is folded a plurality of times in a zigzag form so that the same surfaces of the separator 230 face each other.

Before the positive electrode plates 210a, 210b, 210c, 210d and 210e and the negative electrode plates 220a, 220b, 220c, 220d and 220e are stacked, the separator 230 is first folded at a constant interval. In this instance, the interval may be properly adjusted according to the size of electrode members between which the separator 230 will be located.

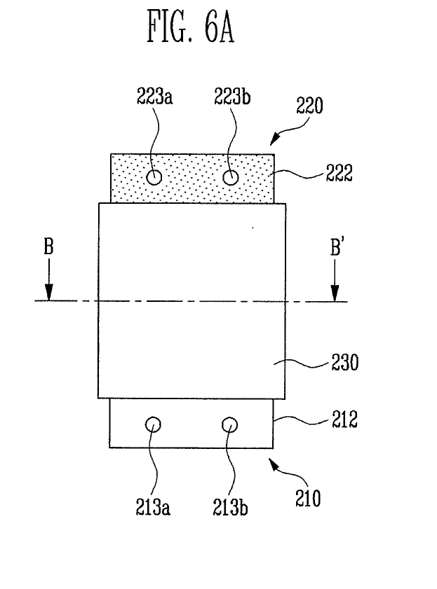

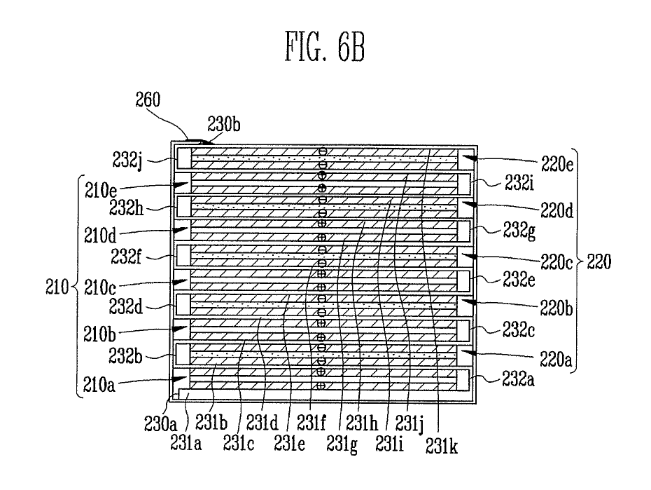

FIG. 6A is a plan view showing an upper surface of the electrode assembly according to the embodiment of the present invention. FIG. 6B is a sectional view taken along line B-B′ of FIG. 6A.

Referring to FIGS. 6A and 6B, the separator 230 is folded at a constant interval so that the same surfaces of the separator 230 face each other. The separator 230 includes one or more facing portions 231a, 231b, 231c, 231d, 231e, 231f, 231g, 231h, 231i, 231j, 231k, and one or more connecting portions 232a, 232b, 232c, 232d, 232e, 232f, 232g, 232h, 232i, 232j, 232k that connect between the respective facing portions 231a, 231b, 231c, 231d, 231e, 231f, 231g, 231h, 231i, 231j, 231k. The positive electrode plate 210a, 210b, 210c, 210d and 210e and the negative electrode plate 220a, 220b, 220c, 220d and 220e are alternately stacked between the respective facing portions 231a, 231b, 231c, 231d, 231e, 231f, 231g, 231h, 231i, 231j, 231k so as to be adjacent to each other with the respective facing portions 231a, 231b, 231c, 231d, 231e, 231f, 231g, 231h, 231i, 231j, 231k located therebetween. Thus, the electrode plates do not come in direct contact with each other. An outer end 230b of the separator 230 is attached to an outermost side of the separator 230 by an adhesive tape 260.

Referring to FIG. 6B, in the electrode assembly 200 according to this embodiment, the positive electrode plate 210a is first stacked between the facing portions 231a and 231b, starting from a center portion 230a of the separator 230, and the negative electrode plate 220a is then stacked at an upper side of the positive electrode plate 210a so that the non-coating portion of the positive electrode plate 210a is opposite to the non-coating portion of the negative electrode plate 220a. Thus, the negative electrode plate 220a does not come in direct contact with the positive electrode plate 210a by the facing portion 231b of the separator 230 but is between the other facing portions 231b and 231c. As shown in FIG. 6A, the first and second non-coating portions 212 and 222 are exposed in the opposite directions to each other with the separator 230 located therebetween, so that they do not face each other.

In the electrode assembly 200 manufactured as described above, the positive electrode plates 210a, 210b, 210c, 210d and 210e and the negative electrode plates 220a, 220b, 220c, 220d and 220e are aligned with the respective facing portions 231a, 231b, 231c, 231d, 231e, 231f, 231g, 231h, 231i, 231j, 231k located therebetween so that the center portions of adjacent two electrode plates are generally aligned.

In a case where a plurality of electrode plates are stacked between the respective facing portions 231a, 231b, 231c, 231d, 231e, 231f, 231g, 231h, 231i, 231j, 231k in the separator 230 folded in the zigzag form, the first and second non-coating portions 212 and 222 are exposed in the opposite directions to each other through the separator 230, and holes in the non-coating portions serve as guides in the stacking so that the stacking position of the non-coating portions can be precisely adjusted.

The holes in the first and second non-coating portions 212 and 222 are aligned to form passages, and projections 213a, 213b, 223a and 223b provided to the first and second electrode leads 240 and 250 pass through the passages. Thus, the projections pass through the passages formed by the holes, so that the first and second electrode leads 240 and 250 can be firmly fastened to the first and second electrode members 210 and 220, respectively. Since other configurations and operations of the electrode assembly 200 are substantially similar to those of the electrode assembly 100 shown in FIG. 2, their detailed descriptions will be omitted.

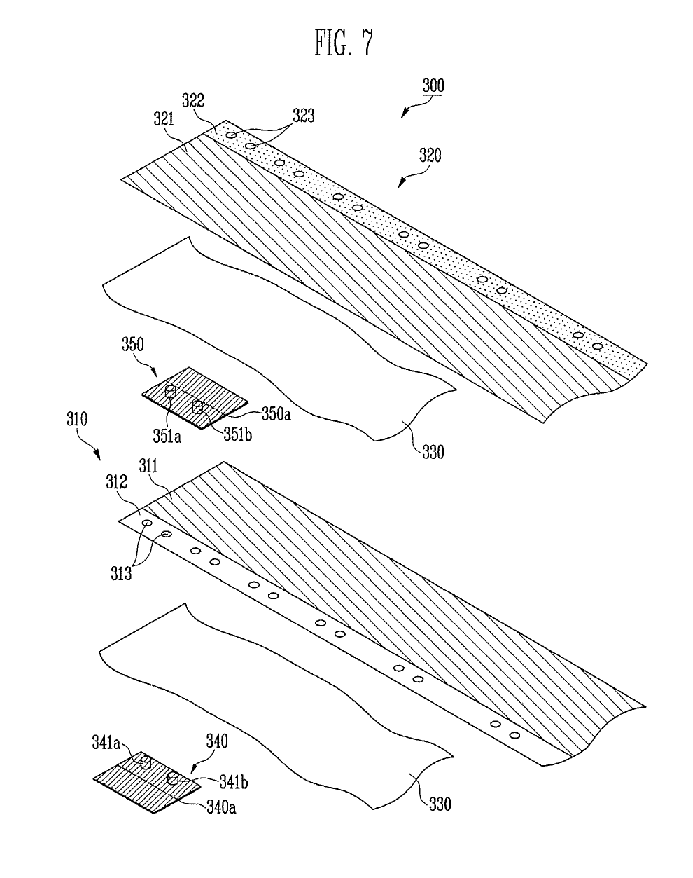

FIG. 7 is an exploded perspective view of an electrode assembly according to still another embodiment of the present invention.

Referring to FIG. 7, the electrode assembly 300 includes a first electrode member 310, a second electrode member 320, a separator 330, a first electrode lead 340 and a second electrode lead 360. The first and second electrode members 310 and 320 and the separator 330 are extended in a sheet shape.

A plurality of holes 313 and 323 are formed in non-coating portions of the first and second electrode members 310 and 320, respectively. In this instance, two adjacent holes 313 form a fastening pair in the plurality of holes 313, and two adjacent holes 323 form a fastening pair in the plurality of holes 323. The fastening pairs of holes 313, 323 are spaced from one another, and the interval between the fastening pairs of holes 313, 323 is gradually widened. Since the configurations and operations of the first and second electrode members 310 and 320, the separator 330 and the first and second electrode leads 340 and 350, except the following description, are substantially similar to those of the embodiments of FIGS. 2 and 5, their detailed descriptions will be omitted.

As described above, two adjacent holes 313, 323 form a pair of fastening openings. When the first and second electrode members 310 and 320 are wound, the fastening pairs of holes 313 formed in the non-coating portion of the first electrode member 310 and the fastening pairs of holes 323 formed in the non-coating portion of the second electrode member 320 may form combined regions, respectively. The interval gradually widened as described above may be determined by the thickness of the first and second electrode members 310 and 320 and the thickness of the separator 330. As the winding of the electrode assembly 300 is performed, the interval between each of the pairs of holes 313 and 323 is increased to generally correspond to the thickness increased by the electrode members and the separator. If the first and second electrode members 310 and 320 and the separator 330 are wound so that the holes 313 and 323 provided to the respective non-coating portions form the combined regions, the holes 313 and 323 serve as guides in the winding. Thus, in the electrode assembly 300 wound using the holes 313 and 323 as guides, the electrode members are easily aligned, so that the failure rate in the winding can be decreased.

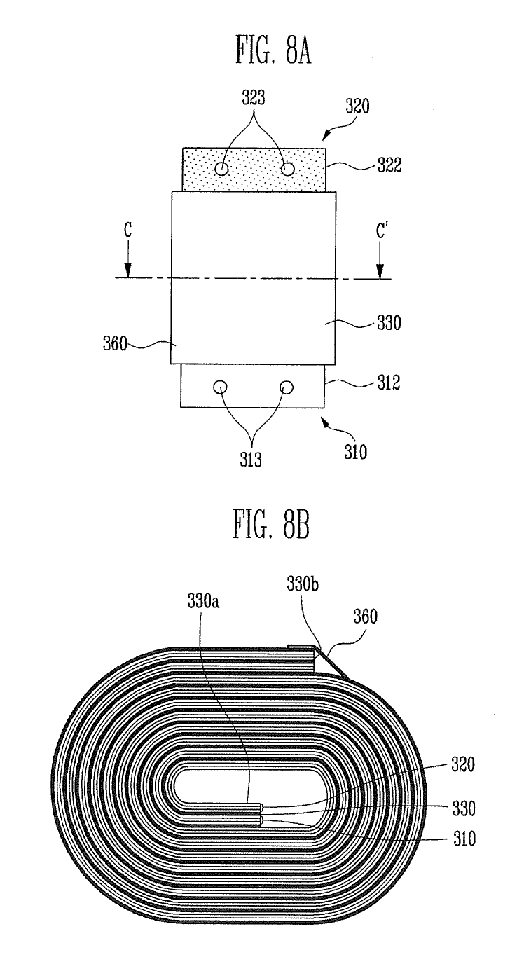

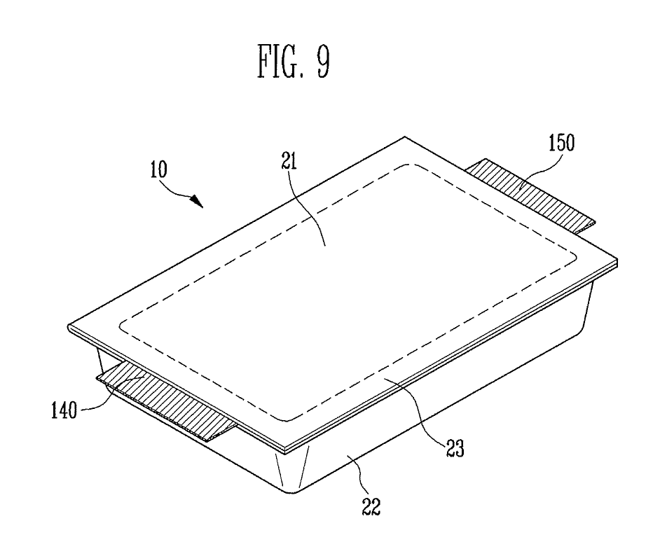

FIG. 8A is a plan view showing an upper surface of the electrode assembly shown in FIG. 7. FIG. 8B is a sectional view taken along line C-C′ of FIG. 8A.

FIG. 8A is a plan view showing the electrode assembly 300 formed by winding the first and second electrode members 310 and 320 and the separator 300 located therebetween. Referring to FIG. 8A, the electrode assembly 300 according to this embodiment is formed by winding the electrode plates stacked so that the non-coating portions of the electrode plates face opposite directions to each other and the separator 330 is located between the electrode plates. Thus, each of the pairs of holes 313 and 314 respectively formed in the first and second non-coating portions 312 and 322 are connected to one another to form a combined region. Two or more openings may form a set of openings with respect to the holes 313 and 323 respectively formed in the non-coating portions of the first and second electrode members 310 and 320 provided after the winding. The spacing interval between the sets of holes 313 and 323 may be changed with respect to the thicknesses of the electrode members and the separator, and the like.

Referring to FIG. 8B, the separator 330 is positioned between the first and second electrode members 310 and 320 to prevent the two electrode members 310 and 320 from coming in direct contact with each other. An outer end 330b of the separator 330 is attached to an outermost side of the separator 330 using an adhesive tape 360.

In the electrode assembly 300 according to this embodiment, the first electrode member 310 that is a positive electrode plate, the separator 330 and the second electrode member 320 that is a negative electrode plate are stacked to face one another, and then wound. In this instance, the first and second non-coating portions 312 and 322 of the first and second electrode members 310 and 320 are stacked to face opposite directions to each other. Thus, the first and second non-coating portions 312 and 322 are exposed in the opposite directions to each other with the separator 330 located therebetween, and the holes 313 and 323 that are in the first and second non-coating portions 312 and 322 are aligned to form passages, respectively. Since other configurations and operations of the electrode assembly 300 are substantially similar to those of the electrode assemblies 100 and 200 shown in FIGS. 2 and 5, their detailed descriptions will be omitted.

FIG. 9 is a perspective view of a secondary battery using the electrode assembly according to the embodiment of the present invention.

Referring to FIG. 9, the secondary battery 10 includes an electrode assembly and a case. The electrode assembly is manufactured according to the aforementioned embodiments and then accommodated in the accommodating portion of the body 22 of the pouch type case. In the state that the body 22 and the cover 21 of the pouch-type case that accommodates the electrode assembly are adhered closely to each other, the sealing portion 230 is sealed through thermal fusion or the like, thereby manufacturing the secondary battery 10. In this instance, the first and second electrode leads 140 and 150 are exposed to the exterior of the case through the sealing portion 23 so that the stacked electrode members are electrically connected to the exterior of the secondary battery 10 (see FIG. 1).

The pouch-type case is provided with an accommodating portion 22a (see FIG. 1) in which the electrode assembly can be mounted and a sealing portion 23. The sealing portion 23 is formed along the outer circumferential surface of the case, and the pouch-type case is sealed through the thermal fusion or the like.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An electrode assembly comprising:
at least one first electrode member;
at least one second electrode member;
a plurality of first guide portions, wherein at least one of the first guide portions is on the first electrode member;
a plurality of second guide portions, wherein at least one of the second guide portions is on the second electrode member; and
a separator located between the first electrode member and the second electrode member, wherein the electrode assembly has a first region at which the first guide portions are coupled together and a second region at which the second guide portions are coupled together.

2. The electrode assembly according to claim 1, wherein the at least one first electrode member and the at least one second electrode member each comprise an active material layer coated with an active material and a non-coating portion at which the active material is not coated, and wherein the first guide portions and the second guide portions are located in the non-coating portion of the at least one first electrode member and the at least one second electrode member, respectively.

3. The electrode assembly according to claim 2, wherein the at least one first electrode member and the at least one second electrode member are alternately stacked so that the first guide portions and the second guide portions are at opposite sides of the electrode assembly from each other.

4. The electrode assembly according to claim 1, wherein the separator is a sheet that is folded onto itself a plurality of times so that a first surface of the separator faces itself.

5. The electrode assembly according to claim 4, comprising a plurality of first electrode members and a plurality of second electrode members, wherein the first electrode members and the second electrode members are alternately stacked between folds of the separator so that the first guide portions and the second guide portions are at opposite sides of the electrode assembly from each other.

6. The electrode assembly according to claim 1, wherein the first guide portions and the second guide portions are generally circular.

7. The electrode assembly according to claim 2, wherein the electrode assembly is wound with the separator between the at least one first electrode member and the at least one second electrode member.

8. The electrode assembly according to claim 7, wherein the first guide portions and the second guide portions are on opposite sides of the electrode assembly.

9. The electrode assembly according to claim 1, wherein the first guide portions are coupled together by first fixing portions and the second guide portions are coupled together by second fixing portions.

10. The electrode assembly according to claim 9, wherein the first fixing portions and the second fixing portions are rivets.

11. The electrode assembly according to claim 10, wherein one of the rivets passes through the first guide portions and wherein one of the rivets passes through the second guide portions.

12. The electrode assembly according to claim 11, wherein welding portions are further formed generally adjacent to each of the rivets.

13. The electrode assembly according to claim 1, further comprising an electrode lead connected to at least one of the first guide portions and the second guide portions.

14. The electrode assembly according to claim 13, wherein the electrode lead comprises a first electrode lead connected to the first guide portions and a second electrode lead connected to the second guide portions, and wherein each of the first and second leads has one or more fixing portions that pass through the first guide portions and the second guide portions, respectively.

15. The electrode assembly according to claim 14, wherein the fixing portions are rivets or projections.

16. The electrode assembly according to claim 15, wherein welding portions are further formed generally adjacent to the rivets or projections.

17. A secondary battery comprising:
an electrode assembly comprising:
at least one first electrode member;
at least one second electrode member;
a plurality of first guide portions, wherein at least one of the first guide portions is on the first electrode member;
a plurality of second guide portions, wherein at least one of the second guide portions is on the second electrode member; and
a separator located between the first electrode member and the second electrode member, wherein the electrode assembly has a first region at which the first guide portions are aligned together and a second region at which the second guide portions are aligned together; and
a case accommodating the electrode assembly.

18. The secondary battery according to claim 1, wherein the case comprises a pouch-type case.
